(19) United States
(12) Patent Application Publication
(10) Pub. No.: US 2022/0270174 A1
(43) Pub. Date: Aug. 25, 2022

(54) Total Financial Management System

(71) Applicant: Kharis J. Quaintance, Jacksonville, FL (US)

(72) Inventor: Kharis J. Quaintance, Jacksonville, FL (US)

(21) Appl. No.: 17/458,982

(22) Filed: Aug. 27, 2021

Related U.S. Application Data
(60) Provisional application No. 63/153,578, filed on Feb. 25, 2021.

(51) Int. Cl. G06Q 40/06; G06Q 40/02; G06F 21/31; H04L 9/08; G06T 11/20

(52) U.S. Cl. CPC G06Q 40/06; G06Q 40/02; G06F 21/31; H04L 9/0863; G06T 11/206; G06F 2221/2113

(57) ABSTRACT

The present invention relates to a computer implemented financial management application which is installed in an electronic device and allows a customer to manage a complete financial portfolio easily and conveniently. The application allows users to view, track, allocate and communicate all financial assets across multiple accounts with any financial institution simultaneously in a single place to easily manage the total financial portfolio. The application accesses multiple financial platforms for simultaneous, real-time updates. The application uses two or more payment networks, debit networks, or a wire transfer of two or more financial institutions and/or insurance institutions to perform the transfer and allocation of funds. The application provides recommendations, graphs, and charts that summarize the financial portfolio and are updated in real time along with the asset allocation. The application provides for a two-factor authentication for logging in to the application.

### CROSS-REFERENCE TO RELATED APPLICATION

The present application claims priority to, and the benefit of, U.S. Provisional Application No. 63/153,578, which was filed on Feb. 25, 2021 and is incorporated herein by reference in its entirety.

### FIELD OF THE INVENTION

The present invention relates generally to the field of financial asset management tools. More specifically, the present invention relates to a financial management software application used to allocate and adjust assets via direct communication with any financial institution for easy and convenient portfolio management. The financial management software application enables the users to track minute-by-minute performance of all financial assets and allows the users to reallocate funds as needed to maximize their portfolio. Additionally, the financial management software application features a secure, two-factor authentication system for logging in to the application and maintaining a proper level of security to prevent unauthorized transactions. Accordingly, the present invention makes specific reference thereto. Nonetheless, it is to be appreciated that aspects of the present invention are also equally applicable to other like applications, devices, and methods of manufacture.

### BACKGROUND OF THE INVENTION

By way of background, people around the world make investments in two or more financial assets placed in different accounts. Usually, people with multiple financial assets placed in different accounts login to each of their accounts to manage their respective financial assets. Individuals have to initially create login credentials for each of their accounts, and then remember their login IDs and passwords for all their accounts to subsequently access the accounts when required. People may not be able to remember all the login credentials or may find it too cumbersome to log in to the accounts, and therefore may fail to check some of their accounts to track their financial assets.

Generally, people have trouble keeping track of all of their accounts. Without keeping track of the accounts on a timely and routine basis, people and businesses may not be fully aware of how their money is being spent or invested. Maximizing savings may not be possible without constant monitoring of all assets. For constant monitoring of assets, individuals are required to constantly log in to multiple different financial institution websites and applications just to instantly view finances, which can be incredibly cumbersome and frustrating. Currently, there does not exist a mechanism to simultaneously monitor all the assets, for an individual, together on a single interface. While an individual monitors and tracks the performance of one asset, there can be a difference in the performance of another, until the individual monitors that asset. Due to improper tracking of performance of assets, individuals may be unable to manage their financial assets to maximize their portfolio.

Therefore, there exists a long-felt need in the art for an interface that allows the users to simultaneously monitor multiple financial assets placed in different accounts. There is also a long-felt need in the art for a solution to allow the users to track the performance of different assets belonging to different accounts, without requiring the users to log in to different websites and applications. Additionally, there is a long-felt need in the art for an interface which eliminates the need to create login credentials for different financial accounts and does not require the user to remember those login credentials for monitoring assets in different accounts. Moreover, there is a long-felt need in the art for an application which allows the user to view all their assets in different accounts through a single interface. Further, there is a long-felt need in the art for an application which allows the users to track minute-by-minute performance of all financial assets and allows the users to manage their assets in order to maximize their portfolio. Furthermore, there is a long-felt need in the art for an application which is secure to use and prevents any unauthorized transactions. Finally, there is a long-felt need in the art for a financial management application which offers a way to maximize profits and finances to track goals and maintain a desired budget.

The subject matter disclosed and claimed herein, in one embodiment thereof, comprises a computer-readable medium-storing software code, representing instructions that when executed by a computing system cause the computing system to perform a method of retrieving and displaying financial information along with maintaining a financial portfolio. The method comprises: simultaneously receiving details of two or more financial accounts of a user to register the accounts; retrieving balance and other compliance information related to the financial accounts from two or more connected financial institutions; displaying the financial information such as balance, interest rate or any debt of the financial accounts of the user; recommending financial transaction and allotment to increase the growth of the financial portfolio of the user; and, displaying graphs and charts to show information about the financial portfolio of the user. The computer-readable medium-storing software code offers a two-factor authentication system for accessing the financial information. Two or more payment networks, debit networks or a wire transfer of two or more financial institutions and/or insurance institutions are used to retrieve financial information and perform financial transactions between the registered accounts of the user.

In this manner, a novel total financial management system (TFMS) application of the present invention accomplishes all of the forgoing objectives, and provides a relatively safe, easy and convenient solution to monitor and actively manage multiple financial assets placed in different accounts without logging in to different websites and applications. The TFMS application of the present invention is also user-friendly, as it does not require the users to remember multiple login credentials, allows users to track minute-to-minute performance of all the financial assets, allows users to reallocate finances and assets to maximize their portfolio, and provides other features to maximize profits and finances in an efficient manner.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer-readable medium-storing software code representing instructions that when executed by a computing system cause the computing system to perform a method of retrieving and displaying financial information along with maintaining a financial portfolio. The method comprises: simultaneously receiving details of two or more financial accounts of a user to register the accounts; retrieving balance and other compliance information related to said financial accounts from two or more connected financial institutions; displaying the financial information such as balances, interest rates, or any debt statements of the financial accounts of the user; recommending financial transaction and allotment to increase the growth of financial portfolio of the user; and, displaying graphs and charts to show information about the financial portfolio of the user. The computer-readable medium-storing software code offers two-factor authentication system for accessing the financial information. Two or more payment networks, debit networks or a wire transfer of two or more financial institutions and/or insurance institutions are used to retrieve financial information and perform financial transactions between the registered accounts of the user.

In a further embodiment of the present invention, a financial management system to manage complete financial portfolio of a user is disclosed. The system comprises two or more computers including memory, wherein the memory stores computer-readable instructions that, when executed, cause the two or more computers to perform the steps of: obtaining credential information from a user; sending a one-time password (OTP) to complete the login process; receiving the transmitted one-time password to complete a successful authentication of the user; obtaining information simultaneously for two or more financial accounts wherein the financial accounts are on two or more financial platforms; simultaneously retrieving balance and other compliance information of the financial accounts from connected two or more financial platforms; receiving balance alerts for account management of each financial account; designating a source account and a destination account to perform a fund transfer for an inputted amount; displaying the confirmation of a successful transaction; and, updating graphs and charts to show information about the financial portfolio of the user. The financial management system allows independent brokers, businesses, financial managers and more to easily track and allocate finances for all accounts from a single user interface.

The method and application/software of the present invention are particularly advantageous because they provide the users with a smartphone application for allocating and adjusting assets via direct communication with any financial institution for easy and convenient portfolio management. It allows minute-by-minute tracking of performance of all financial assets, and thus allows users to reallocate finances to maximize the return from the portfolio. It offers a way to maximize profits and finances to track goals and maintain a desired budget for the user. The application gains access to multiple financial platforms for simultaneous real-time updates and transactions. The recommendations and graphs allow the user to maintain a good financial profile without the burden of individually accessing a plurality of financial applications. The system can be accessed at any time to maintain and update a financial portfolio with real-time information.

The invention uses existing payment networks, debit networks or a wire transfer of two or more financial institutions and/or insurance institutions. The funds can be settled using automated clearing house (ACH) networks. The invention may also use other types of networks not limited to a star computer network.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of one potential embodiment of a TFMS of the present invention for tracking a user's financial portfolio asset performance across financial institutions in accordance with the disclosed architecture;

FIG. 2 illustrates various possible modules and interfaces of one potential embodiment of the TFMS application of the present invention to assist a user to easily view and track financial portfolio asset performance across financial institutions in accordance with the disclosed architecture;

FIG. 3 illustrates a flow diagram showing the steps of accessing one potential embodiment of the TFMS application of the present invention in accordance with the disclosed architecture;

FIG. 4 illustrates a schematic diagram of the transfer of funds between two accounts using one potential embodiment of the TFMS application of the present invention in accordance with the disclosed architecture;

FIG. 5 illustrates an exemplary user interface of one potential embodiment of the TFMS application of the present invention being used to transfer funds between two accounts in accordance with the disclosed architecture;

FIG. 6 illustrates another exemplary user interface of one potential embodiment of the TFMS application of the present invention showing a portfolio summary of a user's financial accounts in accordance with the disclosed architecture;

FIG. 7 illustrates a flow diagram showing the steps of creating recommendations and graphs using one potential embodiment of the TFMS application of the present invention in accordance with the disclosed architecture; and

FIG. 8 illustrates a flow diagram showing the steps of adding a new financial account to one potential embodiment of the TFMS application of the present invention by a user in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an interface that allows the users to simultaneously monitor multiple financial assets placed in different accounts. There is also a long-felt need in the art for a solution to allow the users to track the performance of different assets belonging to different accounts, without requiring the users to log in to different websites and applications. Additionally, there is a long-felt need in the art for an interface which eliminates the need to create login credentials for different financial accounts and does not requires the user to remember those login credentials for monitoring assets in different accounts. Moreover, there is a long-felt need in the art for an application which allows the user to simultaneously view all his or her assets in different accounts through a single interface. Further, there is a long-felt need in the art for an application which allows the users to track minute-by-minute performance of all financial assets and allows the users to manage their assets in order to maximize their portfolio. Furthermore, there is a long-felt need in the art for an application which is secure to use and prevents any unauthorized transactions. Finally, there is a long-felt need in the art for a financial management application which offers a way to maximize profits and finances to track goals and maintain a desired budget.

The present invention, in one exemplary embodiment, comprises a computer-readable medium-storing software code representing instructions that when executed by a computing system cause the computing system to perform a method of retrieving and displaying financial information along with maintaining financial portfolio in one electronic location. The method comprises: simultaneously receiving details of two or more financial accounts of a user to register the accounts; retrieving balance and other compliance information related to said financial accounts from connected two or more financial institutions; displaying the financial information such as balances, interest rates, or debt statements of the financial accounts of the user; recommending financial transaction and allotment to increase the growth of financial portfolio of the user; and, displaying graphs and charts to show information about financial portfolio of the user. The computer-readable medium-storing software code offers a two-factor authentication system for accessing the financial information. Two or more payment networks, debit networks or a wire transfer of two or more financial institutions and/or insurance institutions is used to retrieve financial information and perform financial transactions between the registered accounts of the user.

The term “computer-readable medium” as used herein refers to any medium that participates in providing instructions to a computer processor for execution. Such a medium may take many forms, including but not limited to, non-volatile media, volatile media, and transmission media. Non-volatile media includes, for example, optical disks, magnetic disks, and other non-powered storage devices. Volatile media includes dynamic memory, such as a main memory.

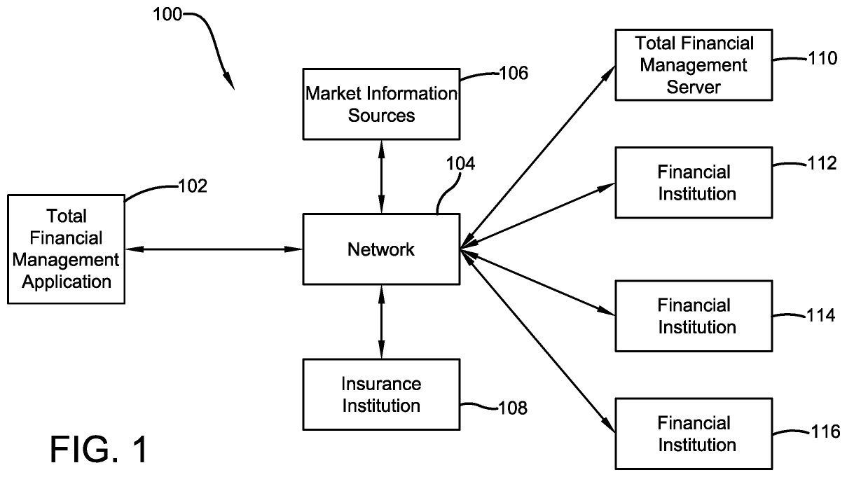

Referring initially to the drawings, FIG. 1 illustrates a schematic diagram of one potential embodiment of a TFMS 100 of the present invention for tracking a user's financial portfolio asset performance across financial institutions in accordance with the disclosed architecture. The TFMS application 102 used by a customer can be a computer-implemented application containing instructions which are executed by a processor of an electronic device in which the TFMS application 102 is installed. The TFMS application 102 allows a user/customer to view, track, allocate and communicate all financial assets (including miscellaneous assets, tangible and intangible) across multiple accounts with a plurality of financial institutions 112, 114, 116 simultaneously, in a single place, to easily manage the user's complete financial portfolio.

The TFMS application 102 accesses the financial accounts of a user by accessing the financial institutions 112, 114, 116 through a network 104 which may be a public network, such as the Internet, online sources, or through a private tunnel over a public network. A user may have the financial accounts in two or more of the financial institutions 112, 114, 116. To track insurance details of the user, the TFMS application 102 may access two or more insurance institutions 108 to display insurance information on the display interface. For additional information, such as securities and market information, market information sources 106 are accessed by the TFMS application 102. It should be appreciated that the TFMS application 102 accesses one or more servers of each of the financial institutions 112, 114, 116, insurance institutions 108 and market information sources 106 to retrieve the desired and allowed information while maintaining the security and privacy of the user personal and financial information.

Additionally, the TFMS application 102 is communicatively-coupled or connected to a Total Financial Management System Server (TFMS server) 110 which stores the user's credentials, personal information, financial information and payment rules set by the user. The TFMS server 110 may also be coupled with two or more of the financial institutions 112, 114, 116, insurance institutions 108 and market information sources 106 through the network 104.

The TFMS application 102 allows a user to perform transactions and allocations in any of the accounts placed in any financial institution. The transactions and allocations are performed with direct communication with a financial institution and may use two or more payment networks, debit networks or a wire transfer of two or more financial institutions and/or insurance institutions. Once a transfer or allocation is authorized by a user in the TFMS application 102, the transfers are initiated to automatically execute the recommended fund adjustments. The changes or updates in any of the associated financial accounts can be reflected in real time in the TFMS application 102 and allows the user to track minute-by-minute performance of all financial assets.

The TFMS application 102 and the system 100 may be used by independent brokers, businesses, financial managers and more, to easily track and allocate finances for all accounts electronically-connected in a single TFMS application 102. All the transactions and allocations are secured and protected and the confidential information is not shared with any third party.

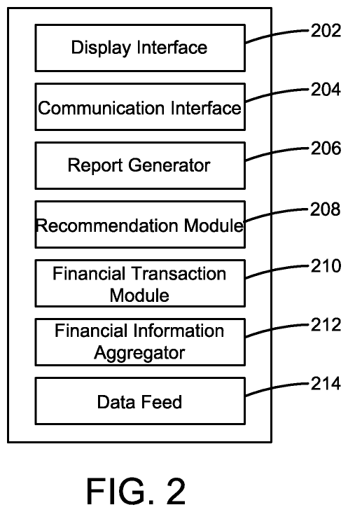

FIG. 2 illustrates various possible modules and interfaces of one potential embodiment of the TFMS application 102 of the present invention to assist a user to easily view and track financial portfolio asset performance across financial institutions in accordance with the disclosed architecture. The TFMS application 102 has a display interface 202 which includes a plurality of user interfaces to allow a user to track, view and perform transactions for easy and convenient portfolio management. The display interface 202 can simultaneously show all the registered financial accounts of a user. A communication interface 204 allows the TFMS application 102 to connect to various financial institutions to perform transactions and allocations using two or more payment networks, debit networks or a wire transfer of two or more financial institutions and/or insurance institutions.

The TFMS application 102 has a report-generating module 206 to generate and display graphs and charts showing the allocations and distribution of assets among multiple financial accounts of a user. The report-generating module 206 creates and displays different types of graphs which are updated in real-time based on the allocation of funds to give insights to a user about his or her financial portfolio. To maximize value of the portfolio of a user, the TFMS application 102 may have a recommendation module 208 which recommends certain allocation tips to the user based on the financial goals and transaction history of the user. The recommendation may be based on higher interest rates, tax profiles and other similar parameters of the user.

The report-generating module 206 may generate various types of reports, such as account activity history, portfolio summary, current recommendations to adjust funds among accounts and/or a report comparing the current market interest rates to the interest rates of a user's current accounts.

The recommendation module 208 applies business logic and interpreting and categorizing financial information to provide value-added portfolio management tools. Examples of business logic may include asset class categorization, comparison of actual to target allocation, personal return calculations, net worth history, and other metrics such as portfolio level return and portfolio risk/volatility.

A financial transaction module 210 performs the transactions and allocations of the funds. The financial transaction module 210 works with the communication interface and allows the user to authorize the transactions and allocations directly from the display interface 202 of the TFMS application. A financial information aggregator 212 aggregates and displays all the financial accounts and insurance information of the user. When adding a new account in their profile of TFMS application and the financial information aggregator module 212, a user retrieves the financial account information and displays same on the user interface using the display interface 202.

A data feed 214 collects market information, insurance information and interest rates by parsing the online information, or may receive information from the TFMS server, which can then be used for recommendations provided to the user and also to provide insights via the graphs and charts. The TFMS can use Artificial Intelligence to provide or ‘pull’ current and customized information specifically related to the clients existing portfolio assets, and can adjust accounts as the assets are added or surrendered to keep the portfolio current.

It may be noted that two or more interfaces or modules of the TFMS application 102 may be in direct communication with the TFMS server to get-real time information about the profile and goals of the user. The TFMS application shows all the registered accounts of the user or account holder, and also allows asset protection by setting balance alerts for two or more financial accounts for account management.

The TFMS application 102 has access to multiple financial platforms for simultaneous and real-time updates. The graphs and charts update in real time with actual balances, along with asset allocation percentages, spending charts, explanations, and updates regarding financial information and more. In one potential embodiment, the data feed 214 of the TFMS application 102 retrieves or ‘pulls’ information (i.e. balances) simultaneously from two or more financial accounts residing in two or more electronically connected financial institutions. Along with the account balances, the data feed 214 of the TFMS application 102 receives or ‘pulls’ data/information simultaneously, or contemporaneously, regarding market information from the internet or online sources. The online sources can be predeterminable by the user. The recommendation module 208 can recommend at least one financial transaction to increase growth of the financial portfolio of the user based upon the market information.

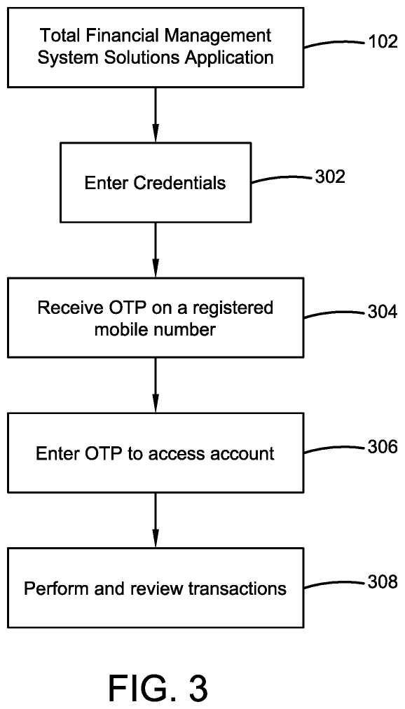

FIG. 3 illustrates a flow diagram showing the steps of accessing one potential embodiment of the TFMS application 102 of the present invention in accordance with the disclosed architecture. Initially, a user opens the TFMS application 102 on an electronic device such as a smartphone, PDA, laptop or other electronic device connected to a web browser (Block 102). Next, a user enters login credentials including a user id and password on the entry interface (Block 302). After receiving the correct credentials, to provide secure login to a user, a One-time Password (OTP) is sent to a registered contact number of the user in the form of a Short Message Service (SMS) as a part of two factor authentication (Block 304). Then, the user enters the OTP to complete the login process to access the personal homepage displaying the portfolio and the registered accounts of the user (Block 306). After accessing the personal homepage, the user may perform and review financial transactions and review the graphs and other financial information (Block 308).

In one embodiment, the OTP may be transmitted to a registered e-mail ID or address of the user in addition to the registered mobile number of the user. The credentials and OTP entered by the user are authenticated by the TFMS server by confirming same with the stored credentials of the user. In another embodiment, the authentication system can include: entering a guest ID and a one-time guest password; receiving the one-time guest password to a registered email address of the user; and, entering the one-time guest password for enabling access of the financial information by the guest.

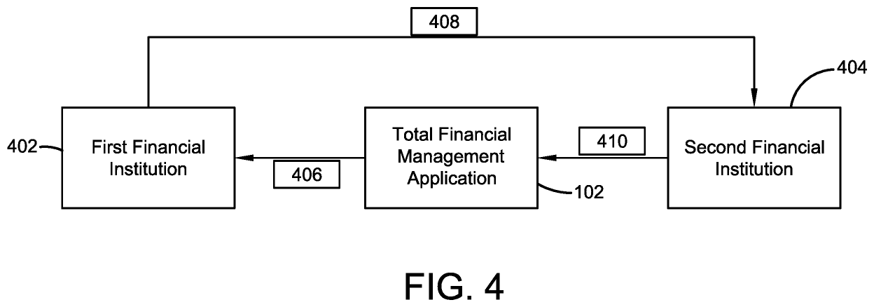

FIG. 4 illustrates a schematic diagram of the transfer of funds between two accounts using one potential embodiment of the TFMS application 102 of the present invention in accordance with the disclosed architecture. More specifically, to transfer funds from a first financial institution 402 to a second financial institution 404, a user designates and performs a funds transfer transaction 406 on the TFMS application 102. The TFMS application 402 directly debits a first account at the first financial institution 402 and credits a second account at the second financial institution 404. The amount is credited to the second account at the second financial institution directly via the transfer request 408. The second financial institution 404 updates the TFMS application 102 through the connection 410.

All the transactions performed through the TFMS application 102 are executed using the two or more payment networks, debit networks or a wire transfer of two or more financial institutions and/or insurance institutions. The transactions and the updated balances are displayed on the TFMS application 102 in real-time and thus the accounts are managed easily through a single user interface.

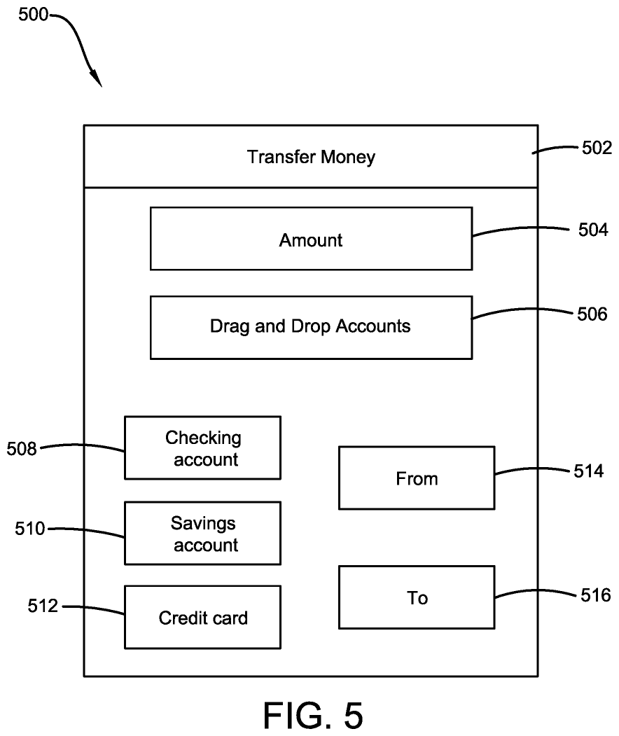

FIG. 5 illustrates an exemplary user interface of one potential embodiment of the TFMS application 102 of the present invention being used to transfer funds between two accounts in accordance with the disclosed architecture. As shown, a user first accesses “Transfer Money” user interface 500. On the user interface 500, “transfer money” header 502 is present at the top of the interface 500, and an amount 504 to be transferred is inputted by the user. Then, from a list of accounts such as a checking account 508, a savings account 510, a credit card account 512 or any other account along with their corresponding balances, two or more accounts are chosen by using the header “Drag and Drop Accounts” 506. One account is chosen as the “From” account 514 and another account is chosen as the “To” account 516.

The user interface 500 may display all the registered accounts of the user and a single transfer can be done between any two accounts chosen by the user. The real-time balances are reflected on the user interface 500 after the transaction is complete.

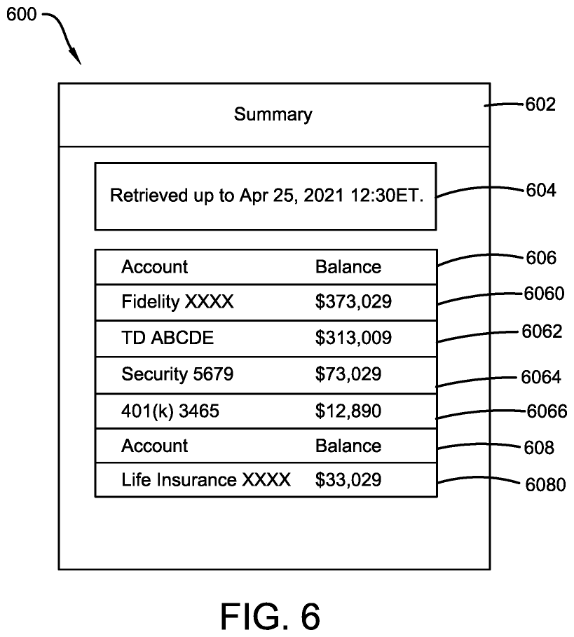

FIG. 6 illustrates another exemplary user interface of one potential embodiment of the TFMS application 102 of the present invention showing a portfolio summary of a user's financial accounts in accordance with the disclosed architecture. More specifically, the “Summary” user interface 600 has a Summary header 602. A timestamp 604 indicating the time and date when the balance in the accounts has updated is shown on the upper half of the user interface. All the registered accounts of a user are shown on the user interface. As shown, an upper table 606 displays the general accounts and the corresponding balance of each account. The user in the present embodiment has four accounts which are shown separately in different rows for access and enablement of actions. Row 6060 shows that Fidelity XXXXXX account has balance $373,029. Similarly, row 6062 shows that TD ABCDE account has balance $313,009. Row 6064 shows that Security 5679 account has balance $73,029. Row 6066 shows that 401(K) 3465 has balance $12,890. In a separate table 608, other types of accounts such as insurance accounts and corresponding balances can be displayed. As an example, row 6080 shows that the insurance account Life insurance XXXXXX has the premium balance $33,029.

It should be appreciated that a user can add any type of financial account to the TFMS application of the present invention. Different types of accounts are shown in different tables on a single user interface for user convenience. Summary of each type of account gives a snapshot of the portfolio summary to the user and payment actions for transfer of funds can be easily performed from the summary page for any financial account.

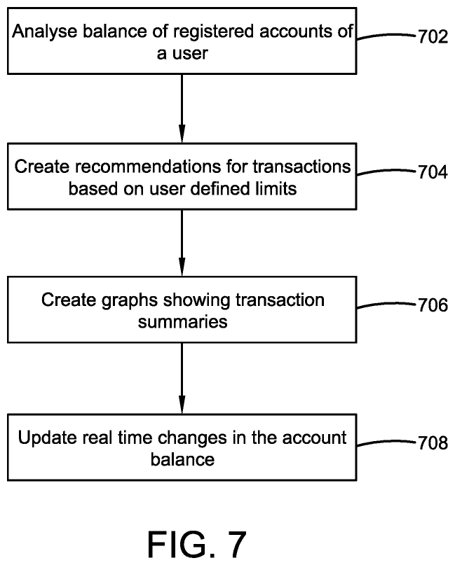

FIG. 7 illustrates a flow diagram showing the steps of creating recommendations and graphs using one potential embodiment of the TFMS application 102 of the present invention in accordance with the disclosed architecture. Initially, the TFMS application 102 analyzes the balances of the registered accounts of a user. The application along with the TFMS server analyzes the financial goals, tax liabilities and other profitable options for the user (Block 702). Based on the analyzed parameters, the TFMS application 102 creates and displays recommendations for transactions and fund allotment to the user which also includes the user-defined limits for each account (Block 704). Based on the transferred funds, the TFMS application 102 creates graphs and explanations of the transaction and balance summaries (Block 706). In cases where a transaction or allotment is done by the user on the TFMS application, the changes in the balance of the respective financial accounts are updated in real-time and are reflected in the graphs as well as displayed on the user interface (Block 708).

Recommendations such as best interest rates and tax benefits based on a transaction are provided to the user. The recommendations help a user in making an effective transaction. In one embodiment, there may be a subscription service offered by TFMS application to provide expert advice to the user and can include live chat features as well with a financial expert. The customer service of individual financial institutions can also be accessed from the TFMS application of the present invention.

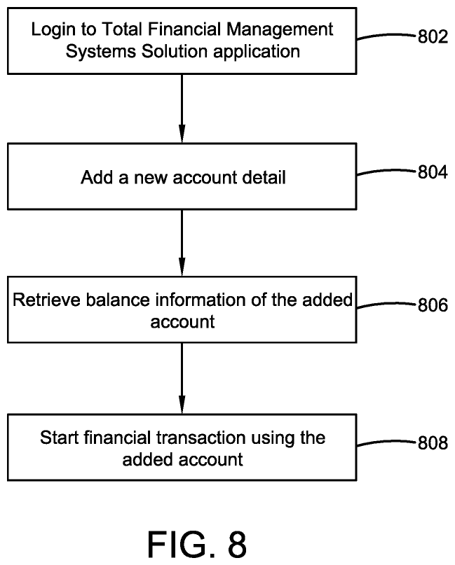

FIG. 8 illustrates a flow diagram showing the steps of adding a new financial account to one potential embodiment of the TFMS application 102 of the present invention by a user in accordance with the disclosed architecture. Initially, a user logs in to the TFMS application 102 of the present invention using credentials and the OTP (Block 802). A user can add a new financial account wherein the account may be a checking account, a savings account, an investment account, a retirement account, a Health Savings Account (HSA), an insurance policy, credit card or debit card. A user interface is shown to the user to add a new account (Block 804). Once the account is added to the TFMS application, the TFMS application retrieves the balance and other financial information of the user from the financial institution in which the financial account is present. The financial information is displayed to the user on the user interface (Block 806). Then, the user may start performing the transactions or allotments using the newly added account, whereby the graphs and other insights start including the balance details of the added account (Block 808).

The system and application of the present invention intelligently aggregates financial information of a plurality of financial accounts into a financial portfolio. Such integration allows for inter-relationships among financial information to be established. Further, the integration provides an automated processing of financial information such that calculations, projections and other operations can be performed on the data included in the information.

The present invention allows a user to allocate and adjust assets via direct communication with any financial institution for easy and convenient portfolio management. A user can track minute-by-minute performance of all financial assets, allowing the user to reallocate funds to increase returns on the portfolio. The invention allows independent brokers, businesses, financial managers, and more, to easily track and allocate funds for all accounts in a single location. A user need not operate a plurality of financial applications to track and manage his or her complete financial portfolio.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “total financial management system application”, “TMFS application”, “financial management application”, and “smartphone application” are interchangeable and refer to the TFMS application 102 of the present invention. Similarly, as used herein “TFMS system” and “financial management system” are interchangeable and refer to the TFMS system 100 of the present invention.

Notwithstanding the forgoing, the TFMS application 102 and the system 100 of the present invention can include any additional components to enhance the functionality and efficiency of the TFMS application 102 and the system 100. One of ordinary skill in the art will appreciate that the configuration and components of the system 100 and the TFMS application 102 as shown in the FIGS. are for illustrative purposes only, and that many other configurations and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of managing a financial portfolio of a user, the method comprising the steps of:
retrieving a plurality of financial information of the user;
maintaining a financial portfolio of said plurality of financial information in one electronic location;
displaying said financial portfolio of said plurality of financial information;
receiving details simultaneously of two or more financial accounts of said user to register said two or more financial accounts;
retrieving balances simultaneously of said two or more financial accounts from two or more connected financial institutions;
recommending at least one financial transaction to increase the growth of said financial portfolio of said user; and
transferring said at least one financial transaction from at least one account to said at least another account.

2. The method of claim 1, wherein said at least one financial transaction comprising at least one of a payment network, a debit network, or a wire transfer from said two or more connected financial institutions.

3. The method of claim 2, wherein said plurality of financial information is selected from a group consisting of an account balance, an interest rate, and a debt statement.

4. The method of claim 3, wherein said displaying said financial portfolio of said plurality of financial information comprises a graph.

5. The method of claim 3, wherein said displaying said financial portfolio of said plurality of financial information comprises a chart.

6. The method of claim 2 further comprising a step of accessing said plurality of financial information through a computer-readable medium storing a software code including a two-factor authentication system.

7. The method of claim 6, wherein said two-factor authentication system comprises:
entering a user ID and a user password;
receiving a one-time password to a registered contact number of said user; and
entering said one-time password.

8. The method of claim 6, wherein said two-factor authentication system comprises:
entering a user ID and a user password;
receiving a one-time password to a registered email address of said user; and
entering said one-time password.

9. A method of managing a financial portfolio of a user, the method comprising:
establishing a financial management system;
obtaining credential information from said user;
accessing said financial portfolio through a computer-readable medium storing software code including a two-factor authentication system, wherein said two-factor authentication system includes entering a user ID and a user password;
transmitting a one-time password;
receiving said one-time password to a registered contact number of said user;
entering said one-time password to complete said two-factor authentication of said user;
obtaining information simultaneously for two or more financial accounts, wherein the financial accounts are on two or more financial platforms;
retrieving balances simultaneously of said two or more financial accounts from connected said two or more financial platforms;
receiving balance alerts for account management of said two or more financial accounts;
designating a source account and a destination account to perform a fund transfer for an inputted amount from said source account of said two or more financial accounts to said destination account of said two or more financial accounts; and
displaying a confirmation of said fund transfer.

10. The method of claim 9 further comprising a step of updating a graph and a chart to show an information about said financial portfolio of said user.

11. The method of claim 9, wherein said fund transfer comprising at least one of a payment network, a debit network, or a wire transfer from said two or more financial accounts.

12. The method of claim 9, wherein said financial portfolio is information selected from a group consisting of an account balance, an interest rate, and a debt statement.

13. A system of storing software code representing instructions that when executed by a computing system causes the computing system to perform a method of managing a complete financial portfolio of a user, the method comprising:
retrieving financial information of a user;
maintaining a financial portfolio of said financial information in one electronic location;
displaying said financial portfolio of said financial information;
receiving details simultaneously of two or more financial accounts of said user to register said two or more financial accounts;
retrieving balances simultaneously of said two or more financial accounts from two or more connected financial institutions;
receiving data feeds simultaneously regarding market information from online sources;
recommending at least one financial transaction to increase the growth of said financial portfolio of said user based upon said market information;
wherein said at least one financial transaction is based on business logic selected from the group consisting of a comparison of actual to target allocation, a personal return calculation, a net worth history, and a risk assessment of said financial portfolio; and
transferring said at least one financial transaction from at least one account to said at least another account.

14. The method of claim 13, wherein said at least one financial transaction comprising at least one of a payment network, a debit network, or a wire transfer from said two or more connected financial institutions.

15. The method of claim 14, wherein said financial information is information selected from a group consisting of an account balance, an interest rate, and a debt statement.

16. The method of claim 15, wherein said displaying said financial portfolio of said financial information comprises a graph.

17. The method of claim 15, further comprising accessing said financial information through a computer-readable medium storing software code including a two-factor authentication system.

18. The method of claim 17, wherein said two-factor authentication system comprises:
entering a user ID and a user password;
receiving a one-time password to a registered contact number of said user; and
entering said one-time password.

19. The method of claim 17, wherein said two-factor authentication system comprises:
entering a user ID and a user password;
receiving a one-time password to a registered email address of said user; and
entering said one-time password.

20. The method of claim 17, wherein said two-factor authentication system comprises:
entering a guest ID and a one-time guest password;
receiving said one-time guest password to a registered email address of said user; and
entering said one-time guest password for enabling access of said financial information by said guest.
